(19) United States
(12) Patent Application Publication
(10) Pub. No.: US 2025/0096375 A1
(43) Pub. Date: Mar. 20, 2025

(54) PACKAGING MATERIAL FOR POWER STORAGE DEVICE AND POWER STORAGE DEVICE INCLUDING PACKAGING MATERIAL

(71) Applicant: TOPPAN HOLDINGS INC., Tokyo (JP)

(72) Inventors: Taketo NUMAZAWA, Tokyo (JP); Koji MURATA, Tokyo (JP)

(73) Assignee: TOPPAN HOLDINGS INC., Tokyo (JP)

(21) Appl. No.: 18/962,813

(22) Filed: Nov. 27, 2024

Related U.S. Application Data
(63) Continuation of application No. PCT/JP2023/019125, filed on May 23, 2023.

(30) Foreign Application Priority Data
May 30, 2022 (JP) 2022-087458

(51) Int. Cl. H01M 50/129; H01M 50/119; H01M 50/121; H01M 50/172

(52) U.S. Cl. CPC H01M 50/129; H01M 50/119; H01M 50/121; H01M 50/172

(57) ABSTRACT

A packing material for a power storage device includes a laminated structure including a substrate layer, a first adhesive layer, a metal foil layer, a second adhesive layer, and a sealant layer in this order, the second adhesive layer including a reaction product of at least acid-modified polyolefin and a multifunctional isocyanate compound, and the second adhesive layer satisfies a condition expressed by an inequality of the following Formula (1): 0.01≤{(C+D)−B}/A≤0.60 . . . (1) [where A to D represent intensities in infrared absorption spectra of the second adhesive layer measured by infrared spectroscopy, A represents a maximum intensity between wavenumbers 3040 and 2760 cm-¹, B represents a maximum intensity between wavenumbers 1850 and 1780 cm-¹, C represents a maximum intensity between wavenumbers 1760 and 1600 cm-¹, and D represents a maximum intensity between wavenumbers 2150 and 2090 cm-¹.]

### CROSS-REFERENCE TO RELATED PATENT APPLICATIONS

This application is a continuation application filed under 35 U.S.C. § 111(a) claiming the benefit under 35 U.S.C. § § 120 and 365(c) of International Patent Application No. PCT/JP2023/019125, filed on May 23, 2023, which is based upon and claims the benefit to Japanese Patent Application No. 2022-087458, filed on May 30, 2022, the disclosures of all which are incorporated herein by reference in their entirety.

### TECHNICAL FIELD

The present disclosure relates to a packaging material for a power storage device and a power storage device including this packaging material.

### BACKGROUND

For example, secondary batteries such as lithium-ion batteries, nickel hydride batteries, and lead storage batteries and electrochemical capacitors such as electric double layer capacitors have been known as power storage devices. Power storage devices have been requested to be further smaller because of smaller mobile devices, limited installation spaces, or the like. lithium-ion batteries each having high energy density thus have attracted attention. Multilayer films having light weight, high heat dissipation performance, and low fabrication cost have been used as packaging materials used for lithium-ion batteries.

Lithium-ion batteries including the multilayer films described above as packaging materials are referred to as laminated lithium-ion batteries. Each of the packaging materials covers the battery contents (such as a positive electrode, a separator, a negative electrode, and an electrolytic solution) and prevents moisture from entering the inside. Laminated lithium-ion batteries are each manufactured, for example, by forming a recess in a part of the packaging material by cold forming, accommodating the battery contents in the recess, folding the remaining parts of the packaging material, and sealing the edge portions by heat sealing (see, for example, PTL 1).

### [CITATION LIST][PATENT LITERATURE]

PTL 1: JP 2013-101765 A

### SUMMARY OF THE INVENTION

### Technical Problem

Incidentally, power storage devices referred to as solid-state batteries have been researched and developed as next-generation batteries replacing lithium-ion batteries. Solid-state batteries have characteristics that the solid-state battery does not include an organic electrolytic solution as an electrolytic substance but includes a solid electrolyte. It is not possible to use a lithium-ion battery under a condition of temperature higher than the temperature (about 80° C.) of the boiling point of the electrolytic solution. In contrast, it is possible to use a solid-state battery under a condition of temperature higher than 100° C. and increase the conductivity of lithium-ions by activating the solid-state battery under a condition of high temperature (e.g., 100 to 150° C.).

However, in a case where the multilayer film as described above is used as the packaging material to manufacture a laminated solid-state battery, insufficient heat resistance of the packaging material may make it impossible to secure interlayer adhesion in a high-temperature environment, and may decrease the lamination strength and decrease the hermeticity of the package of the solid-state battery. The packaging material has a structure in which, for example, a substrate layer, a metal foil layer, and a sealant layer are laminated with adhesive layers or the like in between, but the adhesion between the metal foil layer and the sealant layer easily decreases in a high-temperature environment.

In addition, a sulfide-based solid electrolyte used for the solid-state battery reacts to moisture in the atmospheric air to generate hydrogen sulfide gas and decreases the performance of the battery in some cases. An adhesive used for the inner layer side typically includes a urethane adhesive and an epoxy adhesive as adhesives each having heat resistance. These adhesives do not, however, have sufficient moisture barrier properties. In addition, examples of an adhesive having high moisture barrier properties include an acid-modified polyolefin-based adhesive. These adhesives do not, however, have sufficient heat resistance. In this way, the heat resistance and the moisture barrier properties of an adhesive have a trade-off relationship. The packaging material used for the solid-state battery is then requested to have excellent moisture barrier properties even in a high-temperature environment.

An aspect of the present disclosure provides a packaging material that has excellent heat resistance and has excellent moisture barrier properties even in a high-temperature environment.

### Solution to Problem

An aspect of the present disclosure is a packaging material for a power storage device. The packaging material includes a laminated structure including a substrate layer, a first adhesive layer, a metal foil layer, a second adhesive layer, and a sealant layer in this order, in which the second adhesive layer includes a reaction product of at least acid-modified polyolefin and a multifunctional isocyanate compound, and the second adhesive layer satisfies a condition expressed by an inequality of the following Formula (1):

$$0.01 \leq \{ ( C + D ) - B \} / A \leq 0 \text{.60} \qquad ( 1 )$$

[where A to D represent intensities in infrared absorption spectra of the second adhesive layer measured by infrared spectroscopy, A represents a maximum intensity between wavenumbers of 3040 and 2760 cm-¹, B represents a maximum intensity between wavenumbers 1850 and 1780 cm-¹, C represents a maximum intensity between wavenumbers 1760 and 1600 cm-¹, and D represents a maximum intensity between wavenumbers of 2150 and 2090 cm-¹.]

The packaging material described above has excellent heat resistance and moisture barrier properties. The inventors of the present application consider the reason why such effects are attained to be as follows. That is, the reaction product of the acid-modified polyolefin and the multifunctional isocyanate compound included in the second adhesive layer has a urethane bond. The urethane bond is a polar group and the adhesion between the second adhesive layer and the metal foil layer thus increases. In addition, the reaction product of the acid-modified polyolefin and the multifunctional isocyanate compound has a crosslinking structure caused by a reaction between the carboxylic acid in the acid-modified polyolefin and the multifunctional isocyanate compound. This also increases the heat resistance of the second adhesive layer itself.

In addition, in a case where a typical acid-modified polyolefin is used, the molecular chains of the acid-modified polyolefin are untangled in a high-temperature environment because the glass transition temperature is low. This causes molecules to have wider gaps and the moisture barrier properties of the packaging material decrease. In contrast, in a case where the reaction product of the acid-modified polyolefin and the multifunctional isocyanate compound is used, a crosslinking structure produced by the multifunctional isocyanate compound is constructed between a plurality of acid-modified polyolefin molecules. This increases the glass transition temperature and makes it less easy to untangle molecular chains.

It is then defined that {(C+D)−B}/A (also referred to as “X” below) is 0.01 or more and 0.60 or less with respect to an infrared absorption peak measured by infrared spectroscopy for the second adhesive layer. A represents the maximum intensity between wavenumbers 3040 and 2760 cm-¹ derived from the olefin structure of the reaction product described above, B represents the maximum intensity between wavenumbers 1850 and 1780 cm-¹ derived from the maleic anhydride structure of the reaction product described above, C represents the maximum intensity between wavenumbers 1760 and 1600 cm-¹ derived from a urethane bond of the reaction product described above, and D represents the maximum intensity between wavenumbers 2150 and 2090 cm-¹ derived from the carbodiimide compound. X is 0.01 or more, thereby causing the second adhesive layer to have sufficient urethane bonds. This makes the interlayer adhesive force and the heat resistance of the second adhesive layer itself excellent. In addition, X is 0.60 or less, thereby making it possible to reduce the affinity of the second adhesive layer for water molecules and also reduce the gap between molecules by the crosslinking structure. This causes the packaging material to have excellent heat resistance and moisture barrier properties. In addition, the packaging material also has excellent hydrogen sulfide resistance.

According to an aspect, at least one selected from a group of a multimer of an aliphatic multifunctional isocyanate compound and a multimer of a multifunctional isocyanate compound including an aromatic ring may be included. In a case where the multifunctional isocyanate compound is a multimer of an aliphatic multifunctional isocyanate compound, the gap between molecules produced by a crosslinking reaction decreases as compared with a large isocyanate compound such as a multimer of isophorone diisocyanate. The packaging material therefore has more excellent moisture barrier properties. In addition, in a case where the multifunctional isocyanate compound is a multimer of a multifunctional isocyanate compound including an aromatic ring, interaction (π-π stacking) between aromatic rings decreases the distance between molecules. The packaging material therefore tends to have more excellent moisture barrier properties.

According to an aspect, the packaging material may include an anticorrosion treatment layer between the first adhesive layer and the metal foil layer or between the second adhesive layer and the metal foil layer, or anticorrosion treatment layers between the first adhesive layer and the metal foil layer and between the second adhesive layer and the metal foil layer. The packaging material includes an anticorrosion treatment layer, thereby increasing the adhesion between the adhesive layer provided with the anticorrosion treatment layer and the metal foil layer. This causes the packaging material described above to tend to have more excellent heat resistance. In addition, an anticorrosion treatment layer imparts hydrogen sulfide resistance to the packaging material. This causes the packaging material to tend to have excellent heat resistance even after hydrogen sulfide exposure.

According to an aspect, the sealant layer may include at least one of a polyolefin-based resin and a polyester-based resin. These resins each have, for example, a higher melting point than that of an acryl-based resin. In addition, these resins are compatible with the second adhesive layer including the reaction product of the acid-modified polyolefin and the multifunctional isocyanate compound and have excellent adhesiveness. In addition, these resins each have, for example, more excellent flexibility than that of an acryl-based resin. In addition, these resins each have, for example, lower affinity with a water molecule than that of an acryl-based resin. The packaging material therefore tends to have more excellent heat resistance and moisture barrier properties.

According to an aspect, at least one of the first adhesive layer and the second adhesive layer may include a hydrogen sulfide adsorbent. This causes the packaging material to tend to have more excellent heat-resistant lamination strength even after hydrogen sulfide exposure.

According to an aspect, the second adhesive layer may further include a carbodiimide compound. This causes the packaging material to tend to have more excellent heat resistance. The inventors of the present application assume that such effects are attained because a carbodiimide group having high polarity forms a hydrogen bond to another polar group in the metal foil layer or the second adhesive layer.

The packaging material described above may be for a solid-state battery.

Another aspect of the present disclosure is a power storage device including: a power storage device body; a current output terminal that extends from the power storage device body; and the packaging material. The packaging material pinches the current output terminal and accommodates the power storage device body. The power storage device may be a solid-state battery.

### Advantageous Effects of the Invention

According to an aspect of the present disclosure, a packaging material is provided that has excellent heat resistance and has excellent moisture barrier properties even in a high-temperature environment.

### BRIEF DESCRIPTION OF THE DRAWINGS

FIG. 1 is a schematic cross-sectional view of a packaging material for a power storage device according to an embodiment of the present disclosure.

FIG. 2 is a schematic diagram illustrating an example of an infrared absorption spectrum of a second adhesive layer that is measured by infrared spectroscopy.

FIG. 3 is a perspective view of a power storage device according to an embodiment of the present disclosure.

### DETAILED DESCRIPTION

Preferred embodiments of the present disclosure will be described in detail below with reference to the drawings as appropriate. It is to be noted that the same or corresponding portions will be denoted by the same reference signs in the drawings and duplicate description will be omitted. In addition, the dimensional ratios in the drawings are not limited to the illustrated ratios.

### [Packaging Material for Power Storage Device]

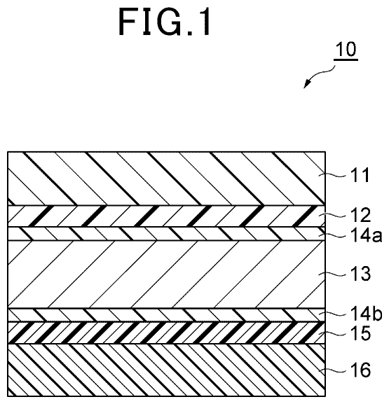

FIG. 1 is a schematic cross-sectional view of an embodiment of a packaging material for a power storage device of the present invention. As illustrated in FIG. 1, a packaging material (a packaging material for a power storage device) 10 according to the present embodiment is a laminate in which a substrate layer 11, a first adhesive layer 12 provided on one of the surfaces of the substrate layer 11, a metal foil layer 13 provided on the opposite side of the first adhesive layer 12 to the substrate layer 11 and including anticorrosion treatment layers 14a and 14b on both surfaces, a second adhesive layer 15 provided on the opposite side of the metal foil layer 13 to the first adhesive layer 12, and a sealant layer 16 provided on the opposite side of the second adhesive layer 15 to the metal foil layer 13 are laminated. Here, the anticorrosion treatment layer 14a is provided on the surface of the metal foil layer 13 closer to the first adhesive layer 12 and the anticorrosion treatment layer 14b is provided on the surface of the metal foil layer 13 closer to the second adhesive layer 15. In the packaging material 10, the substrate layer 11 is the outermost layer and the sealant layer 16 is the innermost layer. That is, the packaging material 10 is used with the substrate layer 11 facing the outside of the power storage device and the sealant layer 16 facing the inside of the power storage device. The respective layers will be described below.

### <Substrate Layer 11>

The substrate layer 11 serves to impart heat resistance in a sealing step performed when the power storage device is manufactured and restrain the formation of pinholes that may occur during molding or distribution. In particular, in the casing or the like of a packaging material for a large power storage device, it is also possible to impart scratch resistance, chemical resistance, insulating properties, and the like.

It is preferable that the substrate layer 11 have a peak melting temperature higher than the peak melting temperature of the sealant layer 16. The substrate layer 11 has a peak melting temperature higher than the peak melting temperature of the sealant layer 16, thereby making it possible to suppress the appearance from being impaired due to the melting of the substrate layer 11 (outer layer) at the time of heat sealing. In a case where the sealant layer 16 has a multilayer structure, the peak melting temperature of the sealant layer 16 means the peak melting temperature of the layer having the highest peak melting temperature. The peak melting temperature of the substrate layer 11 is preferably 290° C. or more and more preferably 290 to 350° C. Resin films that are each usable as the substrate layer 11 and each have a peak melting temperature within the range described above include a nylon film, a PET film, a polyamide film, a polyphenylene sulfide film (PPS film), a polyimide film, a polyester film, and the like. The peak melting temperature means a value obtained in compliance with the method described in JIS K 7121-1987.

A commercially available film may be used as the substrate layer 11 or the substrate layer 11 may be formed by coating (applying and drying a coating liquid). It is to be noted that the substrate layer 11 may have a monolayer structure or a multilayer structure. The substrate layer 11 may be formed by applying a thermosetting resin. In addition, the substrate layer 11 may include, for example, various additives (e.g., a flame retardant, a slip agent, an anti-blocking agent, an antioxidant, a light stabilizer, a tackifier, and the like).

The difference (T₁₁−T₁₆) between a peak melting temperature T₁₁ of the substrate layer 11 and a peak melting temperature T16 of the sealant layer 16 is preferably 20° C. or more. This temperature difference being 20° C. or more makes it possible to more sufficiently suppress the appearance of the packaging material 10 from being impaired due to heat sealing. The thickness of the substrate layer 11 is preferably 5 to 50 μm or more and more preferably 12 to 30 μm.

### <First Adhesive Layer 12>

The first adhesive layer 12 is a layer that bonds the metal foil layer 13 provided with the anticorrosion treatment layer 14a, and the substrate layer 11. The first adhesive layer 12 has adhesion force necessary to firmly bond the substrate layer 11 and the metal foil layer 13 and also has conformability to prevent the substrate layer 11 from damaging the metal foil layer 13 during molding. It is to be noted that the conformability is a property that the first adhesive layer 12 remains on a member instead of being peeling off even if the member is deformed by expansion, contraction, or the like.

Examples of an adhesive component that forms the first adhesive layer 12 include a urethane-based compound, a urea-based compound, an epoxy-based compound, a silicon-based compound, and an inorganic oxide such as aluminum oxide and silica. One of these compounds may be used alone or two or more of these compounds may be used in combination. The urea-based compound is obtained by reacting an amine-based compound and an amine derivative, and a multifunctional isocyanate compound. The urethane-based compound is obtained by reacting a polyol resin and a multifunctional isocyanate compound.

The amine-based compound is a compound including an amino group in a molecule. Here, the amino group means —NH₂, —NHR, or —NR₂. Here, R represents an alkyl group and an aryl group. The amine derivative is a compound that is derived from an amine-based compound and includes no amino group in the molecule.

The amine-based compound and the amine derivative may be overt curing agents or latent curing agents. A latent curing agent is a curing agent that is activated by external stimulation to generate a reactive group which may react to an isocyanate group. In a case where the amine-based compound and the amine derivative are latent curing agents, the pot life tends to increase. Examples of the external stimulation include heat and moisture. Examples of the latent curing agents include an imidazole-based curing agent, an imine-based curing agent, an aminimide-based curing agent, a dicyandiamide-based curing agent, an aromatic polyamine curing agent, an aliphatic polyamine curing agent, a polyamide amine-based curing agent, a tertiary amine salt-based curing agent, and an oxazolidine-based curing agent. Of them, examples of latent curing agents that are activated by heating include an imidazole-based curing agent, a dicyandiamide-based curing agent, a polyamine-based curing agent, and an aminimide-based curing agent. Examples of latent curing agents that are activated by moisture include imine-based curing agents and oxazolidine-based curing agents. A latent curing agent that is activated by moisture is preferable because the pot life tends to increase more.

Examples of the polyol resin include polyester polyol, polyether polyol, polycarbonate diol, and polyacrylic polyol.

Examples of the polyester polyol include polyester polyol obtained by reacting one or more dicarboxylic acids and diol.

Examples of the polyether polyol include what is manufactured by addition-polymerizing ethylene oxide or propylene oxide with propylene glycol, glycerin, pentaerythritol, and the like.

Examples of the polycarbonate polyol include polycarbonate polyol obtained by reacting diester carbonate such as diphenyl carbonate and diol.

Examples of the polyacrylic polyol include a copolymer obtained by copolymerizing at least a hydroxyl group containing acrylic monomer and (meth)acrylic acid. In this case, it is preferable that a structural unit derived from (meth)acrylic acid be included as a main component. Examples of the hydroxyl group containing acrylic monomer include 2-hydroxyethyl (meth)acrylate and 2-hydroxypropyl (meth)acrylate.

The multifunctional isocyanate compound includes a plurality of isocyanate groups and serves to crosslink the amine-based resin or the polyol described above. One of the multifunctional isocyanate compounds may be used alone or two or more of the multifunctional isocyanate compounds may be used in combination. Examples of the multifunctional isocyanate compound include aliphatic multifunctional isocyanate compounds, alicyclic multifunctional isocyanate compounds, and multifunctional isocyanate compounds including an aromatic ring.

Examples of the aliphatic multifunctional isocyanate compound include hexamethylene diisocyanate (HDI), xylylene diisocyanate (XDI), and the like. The alicyclic multifunctional isocyanate compounds include isophorone diisocyanate (IPDI) and the like. The multifunctional isocyanate compounds including an aromatic ring include tolylene diisocyanate (TDI), diphenylmethane diisocyanate (MDI), and the like. It is also possible to use multimers (e.g., trimers) of these compounds as the multifunctional isocyanate compound. Specifically, it is possible to use an adduct, a biuret, an isocyanurate, and the like.

An isocyanate group of the multifunctional isocyanate compound may be bonded to a blocking agent to increase the pot life. Examples of the blocking agent include methylethyl ketone oxime (MEKO) and the like. The temperature at which the blocking agent dissociates from the isocyanate group of the multifunctional isocyanate compound may be 50° C. or more. To increase the pot life more, it is preferable that the temperature be 60° C. or more. The temperature at which the blocking agent dissociates from the isocyanate group of the multifunctional isocyanate compound may be 140° C. or less. To increase the molding curl resistance of the packaging material, it is preferable that the temperature be 120° C. or less.

To decrease the dissociation temperature of the blocking agent, a catalyst that decreases the dissociation temperature may be used. Examples of such a catalyst that decreases the dissociation temperature include tertiary amines such as triethylenediamine and N-methylmorpholine, and metal organic acid salts such as dibutyltin dilaurate.

The first adhesive layer 12 may include a hydrogen sulfide adsorbent because the hydrogen sulfide adsorbent makes it possible to suppress corrosion of the metal foil layer 13 by hydrogen sulfide present outside the packaging material. Examples of such a hydrogen sulfide adsorbent include zinc oxide and potassium permanganate. In a case where the first adhesive layer 12 includes a hydrogen sulfide adsorbent, it is possible to suppress corrosion of the metal foil layer 13 by hydrogen sulfide present outside the packaging material. It is thus preferable that the content thereof be 1 to 50 mass % relative to the total content of the first adhesive layer 12.

To obtain desired adhesive strength, conformability, processability, and the like, the thickness of the first adhesive layer 12 is preferably 1 to 10 μm, and more preferably 2 to 6 μm.

The first adhesive layer 12 is obtained by applying, for example, a composition including the components described above. It is possible to use a publicly known technique as a coating method. Examples thereof include gravure direct coating, gravure reverse coating (direct or kiss coating), and micro-gravure coating.

The composition may include a solvent. Examples of such a solvent include ethyl acetate, toluene, methyl ethyl ketone, methyl isobutyl ketone, and alcohols. One of the solvents may be used alone or two or more of the solvents may be used in combination.

### <Second Adhesive Layer 15>

The second adhesive layer 15 is a layer that bonds the metal foil layer 13 provided with the anticorrosion treatment layer 14b, and the sealant layer 16. The second adhesive layer 15 includes the reaction product (also referred to as a “reaction product A” below) of at least an acid-modified polyolefin and a multifunctional isocyanate compound. The components for obtaining the reaction product A may be acid-modified polyolefin and a multifunctional isocyanate compound alone or may include another component in addition to the acid-modified polyolefin and the multifunctional isocyanate compound. Examples of the other component include a carbodiimide compound, an epoxy resin, an acrylic resin, a silicon resin, a silane coupling agent, a silica filler, aluminum oxide, zinc oxide, a latent curing agent, and an oxidative degradation inhibitor. It is preferable that the reaction product A be a reaction product of at least acid-modified polyolefin, a multifunctional isocyanate compound, and a carbodiimide compound because the reaction product tends to have more excellent heat resistance and moisture barrier properties.

It is preferable that the hydroxyl value of the acid-modified polyolefin be 5 to 120 KOHmg/g from the perspective of reactivity. The hydroxyl value of the acid-modified polyolefin is preferably 10 to 80 KOHmg/g, and more preferably 20 to 60 KOHmg/g.

Examples of the acid-modified polyolefin include maleic anhydride-modified polyolefin obtained by reacting maleic anhydride and polyolefin. Examples of the maleic anhydride-modified polyolefin include maleic anhydride-modified polypropylene and maleic anhydride-modified polyethylene.

The same multifunctional isocyanate compounds may be used as in the first adhesive layer.

It is preferable that the multifunctional isocyanate compound be a multimer of an aliphatic multifunctional isocyanate compound and a multimer of a multifunctional isocyanate compound including an aromatic ring because the packaging material tends to have more excellent moisture barrier properties.

The formulation ratio of a multifunctional isocyanate compound used when at least acid-modified polyolefin and the multifunctional isocyanate compounds are reacted is preferably 0.5 to 40 parts by mass relative to 100 parts by mass of the acid-modified polyolefin from the perspective of reactivity, more preferably 3 to 30 parts by mass, and still more preferably 5 to 20 parts by mass.

The formulation ratio of a carbodiimide compound used when at least acid-modified polyolefin, a multifunctional isocyanate compound, and the carbodiimide compound are reacted is preferably 0.1 to 10 parts by mass relative to 100 parts by mass of the acid-modified polyolefin from the perspective of heat resistance and adhesion, more preferably 0.3 to 7 parts by mass., and still more preferably 0.5 to 5 parts by mass.

The formulation ratio of acid-modified polyolefin may be 60 mass % or more, 70 mass % or more, 80 mass % or more, or 90 mass % or more on the basis of the total content of components for obtaining the reaction product A.

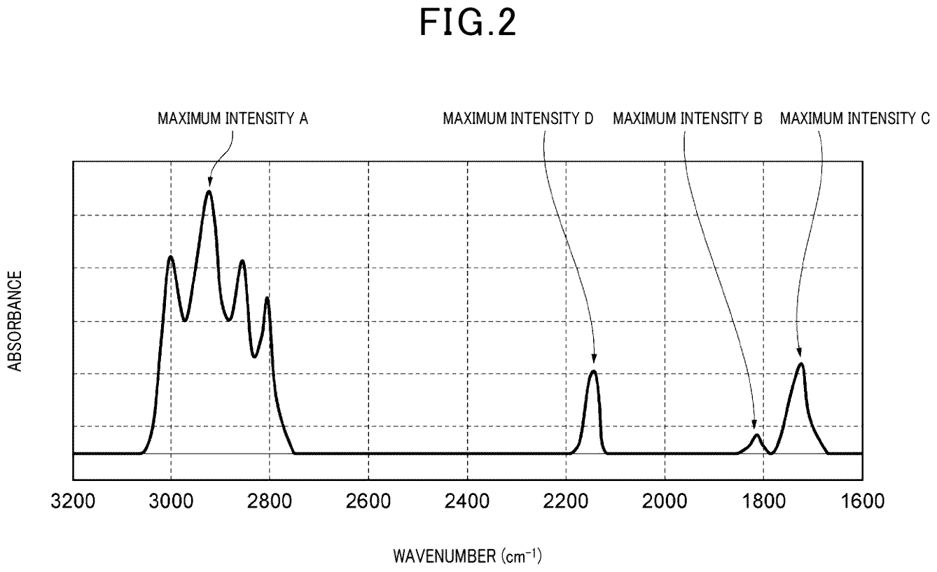

FIG. 2 is a schematic diagram illustrating an example of the infrared absorption spectra of the second adhesive layer 15 measured by infrared spectroscopy. The second adhesive layer 15 satisfies a condition expressed by the inequality of the following Formula (1):

$$0.01 \leq \{ ( C + D ) - B \} / A \leq 0 \text{.60} \qquad ( 1 )$$

[where A to D represent intensities in infrared absorption spectra of the second adhesive layer measured by infrared spectroscopy, A represents a maximum intensity between wavenumbers of 3040 and 2760 cm-¹, B represents a maximum intensity between wavenumbers 1850 and 1780 cm-¹, C represents a maximum intensity between wavenumbers 1760 and 1600 cm-¹, and D represents a maximum intensity between wavenumbers of 2150 and 2090 cm-¹.]

{(C+D)−B}/A is preferably 0.05 or more because of a tendency to offer more excellent heat resistance, more preferably 0.2 or more, and still more preferably 0.3 or more.{(C+D)−B}/A is preferably 0.5 or less because of a tendency to offer more excellent moisture barrier properties., more preferably 0.45 or less, still more preferably 0.4 or less.

It is possible to measure an infrared absorption spectrum peak intensity by attenuated total reflection (ATR: Attenuated Total Reflection) of Fourier transform infrared (FT-IR) spectroscopy.

It is preferable that the second adhesive layer 15 include a carbodiimide compound because the second adhesive layer 15 tends to have more excellent heat resistance. The carbodiimide compound acts on a carboxyl group included in an acid-modified polyolefin as a reaction accelerator and a crosslinking agent.

The second adhesive layer 15 may include a hydrogen sulfide adsorbent as with the first adhesive layer. The type of hydrogen sulfide adsorbent and the content of the hydrogen sulfide adsorbent may be similar to those of the first adhesive layer.

It is preferable that the thickness of the second adhesive layer 15 be 1 to 5 μm. The thickness of the second adhesive layer 15 is 1 μm or more, thereby making it easier to obtain sufficient adhesive strength between the metal foil layer 13 and the sealant layer 16. The thickness of the second adhesive layer 15 is 5 μm or less, thereby demonstrating a tendency to allow the second adhesive layer 15 to be restrained from suffering cracking.

It is possible to obtain the second adhesive layer 15 in a method similar to that of the first adhesive layer 12.

### <Metal Foil Layer 13>

The metal foil layer 13 has water vapor barrier properties to prevent moisture from entering the inside of the power storage device. In addition, the metal foil layer 13 may have ductility for deep drawing. It is possible to use, for example, various metal foils such as an aluminum foil, a stainless steel foil, and a copper foil as the metal foil layer 13. One of these may be used alone or two or more of the solvents may be used in combination. An aluminum foil is preferable as the metal foil layer 13 from the perspective of mass (specific gravity), moisture resistance, processability, and cost.

It is possible to preferably use a soft aluminum foil subjected to annealing treatment in particular as the aluminum foil because it is possible to impart desired ductility at the time of molding. It is more preferable to use an aluminum foil including iron for the purpose of further imparting pinhole resistance and ductility at the time of molding. The content of iron in the aluminum foil is preferably 0.1 to 9.0 mass % relative to 100 mass % of aluminum foil and more preferably 0.5 to 2.0 mass % (e.g., an aluminum foil including the material 8021 or the material 8079 according to JIS standards). The content of iron is 0.1 mass % or more, thereby making it possible to obtain the packaging material 10 having more excellent pinhole resistance and ductility. The content of iron is 9.0 mass % or less, thereby making it possible to obtain the packaging material 10 having more excellent flexibility.

It is preferable that the metal foil used for the metal foil layer 13 be subjected, for example, to degreasing treatment to obtain desired electrolyte resistance. In addition, to simplify the manufacturing step, a metal foil having an unetched surface is preferable as the metal foil described above. Above all, it is preferable to use an aluminum foil subjected to degreasing treatment as the metal foil used for the metal foil layer 13 because the aluminum foil is to impart electrolyte resistance. In a case where the aluminum foil is subjected to degreasing treatment, one of the surfaces of the aluminum foil alone may be subjected to degreasing treatment or both surfaces may be subjected to degreasing treatment. It is possible to use, for example, wet degreasing treatment or dry degreasing treatment as the degreasing treatment described above. However, to simplify the manufacturing step, the dry degreasing treatment is preferable.

Examples of the dry degreasing treatment described above include a method for conducting degreasing treatment by extending the treatment time in a step of subjecting the metal foil to annealing treatment. Even degreasing treatment that is conducted at the same time as the annealing treatment conducted for softening the metal foil offers sufficient electrolyte resistance.

In addition, treatment such as flame treatment and corona treatment that is a treatment other than the annealing treatment described above may be used as the dry degreasing treatment described above. Further, degreasing treatment that oxidatively decomposes and removes a contaminant substance by using, for example, active oxygen generated by irradiating the metal foil with an ultraviolet light having specific wavelengths may be used as the dry degreasing treatment described above.

It is possible to use, for example, treatment such as an acid degreasing treatment or alkaline degreasing treatment as the wet degreasing treatment described above. It is possible to use, for example, an inorganic acid such as sulfuric acid, nitric acid, hydrochloric acid, or hydrofluoric acid as the acid used for the acid degreasing treatment described above. One of these acids may be used alone or two or more of these acids may be used in combination. In addition, it is possible to use, for example, sodium hydroxide having a high etching effect as the alkali used for the alkaline degreasing treatment. In addition, the alkaline degreasing treatment may be conducted by using a weakly alkaline material and a material in which a surfactant or the like is formulated. It is possible to conduct the wet degreasing treatment described above, for example, in an immersion method or a spraying method.

The thickness of the metal foil layer 13 is preferably 9 to 200 μm from the perspective of barrier properties, pinhole resistance, and processability, more preferably 15 to 150 μm, still more preferably 15 to 100 μm. The thickness of the metal foil layer 13 is 9 μm or more, thereby reducing the occurrence of breakage even when stress is applied by molding. The thickness of the metal foil layer 13 is 200 μm or less, thereby making it possible to reduce an increase in the mass of the packaging material and restrain a decrease in the weight energy density of the power storage device.

<Anticorrosion Treatment Layers 14a and 14b>

The anticorrosion treatment layers 14a and 14b are layers provided on the surfaces of the metal foil layer 13 to prevent the metal foil layer 13 from being corroded. In addition, the anticorrosion treatment layer 14a serves to increase the adhesive force between the metal foil layer 13 and the first adhesive layer 12. In addition, the anticorrosion treatment layer 14b serves to increase the adhesive force between the metal foil layer 13 and the second adhesive layer 15. The anticorrosion treatment layer 14a and the anticorrosion treatment layer 14b may be layers having the same configuration or layers having different configurations.

It is possible to form the anticorrosion treatment layers 14a and 14b, for example, by carrying out degreasing treatment, hydrothermal modification treatment, anodizing treatment, chemical modification treatment, or coating-type anticorrosion treatment in which a coating agent having anticorrosion ability is applied, or anticorrosion treatment that is a combination of these treatments on layers serving as the base materials of the anticorrosion treatment layers 14a and 14b.

Of the treatments described above, the degreasing treatment, the hydrothermal modification treatment, and the anodizing treatment, or the hydrothermal modification treatment and the anodizing treatment in particular are treatments for dissolving a surface of the metal foil (aluminum foil) by using a treatment agent and forming a metal compound (aluminum compound (boehmite or alumite)) having excellent anticorrosion properties. Therefore, such treatments may be sometimes embraced within the definition of chemical modification treatment to obtain a structure that forms a co-continuous structure from the metal foil layer 13 to the anticorrosion treatment layers 14a and 14b.

The degreasing treatment includes acid degreasing treatment and alkaline degreasing treatment. Acid degreasing may be performed using inorganic acids such as sulfuric acid, nitric acid, hydrochloric acid, or hydrofluoric acid, alone or in combination.

In addition, as the acid degreasing treatment, the use of an acid degreasing agent containing a dissolved fluorine-containing compound such as monosodium ammonium bifluoride with the inorganic acid described above makes it possible to form a passive-state metal fluoride in addition to an effect of degreasing the metal foil layer 13. This is effective in terms of hydrofluoric acid resistance. The alkaline degreasing treatment includes a method that uses sodium hydroxide or the like.

It is possible to use, for example, boehmite treatment that uses boehmite obtained by conducting treatment of immersing the metal foil layer 13 in boiling water to which triethanolamine is added as the hydrothermal modification treatment described above. It is possible to use, for example, alumite treatment as the anodizing treatment described above. In addition, it is possible to use, for example, chromate treatment, zirconium treatment, titanium treatment, vanadium treatment, molybdenum treatment, calcium phosphate treatment, strontium hydroxide treatment, cerium treatment, ruthenium treatment, or treatment that is a combination of two or more of these as the chemical modification treatment described above. When conducting these hydrothermal modification treatment, anodizing treatment, and chemical modification treatment, it is preferable to conduct the degreasing treatment described above in advance.

It is to be noted that the chemical modification treatment described above is not limited to wet chemical modification treatment. For example, a method may be used in which treatment agents used for these treatments are mixed with a resin component and applied. In addition, coating-type chromate treatment is preferable as the anticorrosion treatment described above because the coating-type chromate treatment maximizes the effect and is convenient for liquid waste disposal.

The coating agent used for the coating-type anticorrosion treatment includes a coating agent containing at least one selected from the group of rare earth element oxide sols, an anionic polymers, and a cationic polymers. In particular, a method is preferable in which a coating agent containing rare earth element oxide sol is used.

The anticorrosion treatment layers 14a and 14b preferably have mass per unit area within a range of 0.005 to 0.200 g/m², and more preferably within a range of 0.010 to 0.100 g/m². If the mass per unit area is 0.005 g/m² or more, it is easier to impart an anticorrosion function to the metal foil layer 13. In addition, even when the mass per unit area described above exceeds 0.200 g/m², the anticorrosion function saturates and no further effect is expectable. It is to be noted that the above description has been given by using mass per unit area. However, if the specific gravity is available, it is also possible to convert the specific gravity to thickness.

The thickness of each of the anticorrosion treatment layers 14a and 14b is preferably, for example, 10 nm to 5 μm from the perspective of anticorrosion function and anchoring function, and more preferably 20 nm to 500 nm.

### <Sealant Layer 16>

The sealant layer 16 is a layer that imparts sealing properties to the packaging material 10 by heat sealing. The sealant layer 16 is a layer that is disposed and subjected to heat sealing (heat-sealed) on the inside when the power storage device is assembled.

Examples of the sealant layer 16 include a film including an acryl-based resin, a polyolefin-based resin, or a polyester-based resin. A film including a polyolefin-based resin or a polyester-based resin is preferable as the sealant layer 16 because the film has a high melting point and provides more increased heat resistance to the packaging material. A film including a polyester-based resin is more preferable.

Examples of the acryl-based resin include a polymethyl methacrylate resin (PMMA) and the like. One of these acryl-based resins may be used alone or two or more of these acryl-based resins may be used in combination.

Examples of the polyolefin-based resin include: low-density, medium-density, and high-density polyethylenes; an ethylene-α olefin copolymer; polypropylene; a propylene-α olefin copolymer; and the like. The polyolefin resin in the case of a copolymer may be a block copolymer or a random copolymer.

Examples of the polyester-based resin include polyethylene terephthalate (PET), polybutylene terephthalate (PBT), and the like. One of these polyester-based resins may be used alone or two or more of these polyester-based resins may be used in combination.

The sealant layer 16 may be a monolayer film or a multilayer film, which may be selected depending on required functions. In a case where the sealant layer 16 has a multilayer configuration, the respective layers may be laminated by co-extrusion or laminated by dry lamination.

The sealant layer 16 may include various additives such as a flame retardant, a slip agent, an anti-blocking agent, an antioxidant, a light stabilizer, and a tackifier.

The thickness of the sealant layer 16 is preferably 10 to 100 μm, and more preferably 20 to 60 μm. If the thickness of the sealant layer 16 is 10 μm or more, it is possible to obtain sufficient heat sealing strength, and if the thickness of the sealant layer 16 is 100 μm or less, it is possible to reduce the amount of water vapor ingress from edges of the packaging material.

It is preferable that the peak melting temperature of the sealant layer 16 be 200 to 280° C. because the heat resistance is to increase more.

It is possible to preferably use the packaging material 10 as a packaging material, for example, for a power storage device such as a secondary battery including a lithium-ion battery, a nickel hydride battery, a lead storage battery, and the like and an electrochemical capacitor including an electric double layer capacitor and the like. Above all, the packaging material 10 is preferable as a packaging material for a solid-state battery including a solid electrolyte assumed to be used in a high-temperature environment because the packaging material 10 has excellent heat resistance and excellent moisture barrier properties even in such an environment.

The preferred embodiments of the packaging material for the power storage device according to the present embodiment have been described above in detail. However, the present disclosure is not limited to these specific embodiments. It is possible to make various alternations and modifications within the scope of the gist of the present disclosure recited in the claims.

For example, FIG. 1 illustrates a case where the anticorrosion treatment layers 14a and 14b are provided on both surfaces of the metal foil layer 13, but any one of the anticorrosion treatment layers 14a and 14b alone may be provided or the anticorrosion treatment layers do not have to be provided.

### [Method for Manufacturing Packaging Material]

Next, a method for manufacturing the packaging material 10 will be described. It is to be noted that the method for manufacturing the packaging material 10 will not be limited to the following methods.

Examples of the method for manufacturing the packaging material 10 include a method in which steps S11 to S13 below are carried out in this order.

Step S11: a step of forming the anticorrosion treatment layer 14a on one of the surfaces of the metal foil layer 13 and forming the anticorrosion treatment layer 14b on the other surface of the metal foil layer 13.

Step S12: a step of bonding the surface of the anticorrosion treatment layer 14a opposite to the metal foil layer 13 and the substrate layer 11 with the first adhesive layer 12 in between.

Step S13: a step of forming the sealant layer 16 on the surface of the anticorrosion treatment layer 14b opposite to the metal foil layer 13 with the second adhesive layer 15 in between.

### <Step S11>

In step S11, the anticorrosion treatment layer 14a is formed on one of the surfaces of the metal foil layer 13 and the anticorrosion treatment layer 14b is formed on the other surface of the metal foil layer 13. The anticorrosion treatment layers 14a and 14b may be formed separately or may be both formed at one time. Specifically, for example, both surfaces of the metal foil layer 13 may be coated with anticorrosion treatment agents (the base materials of the anticorrosion treatment layers), sequentially followed by drying, curing, and baking. This forms the anticorrosion treatment layers 14a and 14b at one time. Alternatively, one of the surfaces of the metal foil layer 13 may be coated with an anticorrosion treatment agent, sequentially followed by drying, curing, and baking to form the anticorrosion treatment layer 14a. After that, the anticorrosion treatment layer 14b may be similarly formed on the other surface of the metal foil layer 13. The formation order of the anticorrosion treatment layers 14a and 14b is not particularly limited. In addition, different anticorrosion treatment agents may be used for the anticorrosion treatment layer 14a and the anticorrosion treatment layer 14b. Alternatively, the same anticorrosion treatment agent may be used. The method for applying an anticorrosion treatment agent is not particularly limited. It is possible to use, for example, a method such as a gravure coating method, a gravure reverse coating method, a roll coating method, a reverse roll coating method, a die coating method, a bar coating method, a kiss coating method, a comma coating method, and a small-diameter gravure coating method.

### <Step S12>

In step S12, the surface of the anticorrosion treatment layer 14a opposite to the metal foil layer 13 and the substrate layer 11 are bonded by a technique such as dry lamination with an adhesive that forms the first adhesive layer 12. In step S12, heating treatment may be conducted to promote the adhesiveness of the first adhesive layer 12. It is preferable that the temperature at the time of heating treatment be 140° C. or less because the packaging material is to have excellent molding curl resistance.

### <Step S13>

After step S12, the surface of the anticorrosion treatment layer 14b opposite to the metal foil layer 13 and the sealant layer 16 in a laminate in which the substrate layer 11, the first adhesive layer 12, the anticorrosion treatment layer 14a, the metal foil layer 13, and the anticorrosion treatment layer 14b are laminated in this order are bonded by a technique such as dry lamination with an adhesive that forms the second adhesive layer 15. In step S13, heating treatment may be conducted to promote adhesiveness of the second adhesive layer 15. The temperature during heating treatment is preferably 140° C. or less, more preferably 120° C. or less, to provide a packaging material having excellent molding curl resistance.

The packaging material 10 is obtained through steps S11 to S13 described above. It is to be noted that the order of steps in the method for manufacturing the packaging material 10 is not limited to that of the method in which steps S11 to S13 described above are sequentially performed. The order of steps to be performed may be changed as appropriate, for example, such as performing step S11 after performing step S12.

### [Power Storage Device]

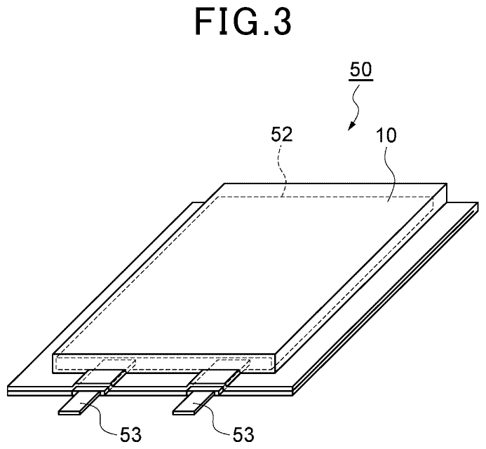

FIG. 3 is a perspective view of an embodiment of a power storage device fabricated by using the packaging material described above. As illustrated in FIG. 3, a power storage device 50 includes a battery element (power storage device body) 52 including electrodes, two metal terminals (leads or current output terminals) 53 that extend from the electrodes described above and are for allowing electric current to be outputted from the battery element 52, and the packaging material 10 that hermetically seals the battery element 52. The packaging material 10 is the packaging material 10 according to the present embodiment described above and is used as a container that accommodates the battery element 52. In the packaging material 10, the substrate layer 11 is the outermost layer and the sealant layer 16 is the innermost layer. That is, one laminate film is folded in half and the peripheral portions are heat-sealed with the substrate layer 11 located on the outside of the power storage device 50 and the sealant layer 16 located on the inside of the power storage device 50, or two laminate films are overlaid and the peripheral portions are heat-sealed to configure the packaging material 10 to contain the battery element 52 therein. The metal terminals 53 are pinched and hermetically sealed by the packaging material 10 that forms the container with the sealant layer 16 located on the inside. The metal terminals 53 may be each pinched by the packaging material 10 with a tab sealant in between.

The battery element 52 has an electrolyte interposed between the positive electrode and the negative electrode. The metal terminals 53 are parts of the current collector extending from the packaging material 10 and are made of a metal foil such as copper foil or aluminum foil.

The power storage device 50 may be a solid-state battery. In this case, a solid electrolyte such as a sulfide-based solid electrolyte is used for the electrolyte of the battery element 52. The power storage device 50 according to the present embodiment includes the packaging material 10 according to the present embodiment, which can secure excellent lamination strength, sealing strength, and moisture barrier properties, even when used in a high-temperature environment (e.g., 150° C.).

### Examples

The present disclosure will be specifically described below on the basis of Examples, but the present disclosure is not limited to these.

<Substrate Layer (Thickness of 25 μm)>

A polyethylene terephthalate film having one surface subjected to corona treatment was used.

<First Adhesive Layer (Thickness of 4 μm)>

A urethane resin (manufactured by Mitsui Chemicals, Inc., trade names “main resin: Takelac A-515 (solid content concentration of 50 mass %) and curing agent: Takenate D-140 (solid content concentration of 74 mass %)”) was prepared as a material of the first adhesive layer. These materials were formulated at a ratio of 30 parts by mass of the curing agent to 100 parts by mass of the main resin, diluted with ethyl acetate to obtain a solid content concentration of 30 mass %, and used as an adhesive.

### <First Anticorrosion Treatment Layer (Closer to Substrate Layer) and Second Anticorrosion Treatment Layer (Closer to Sealant Layer)>

(CL-1): “Sodium polyphosphate stabilized cerium oxide sol” was used that was adjusted to a solid content concentration of 10 mass % by using distilled water as a solvent medium. It is to be noted that the sodium polyphosphate stabilized cerium oxide sol was obtained by formulating 10 parts by mass of Na salt of phosphoric acid relative to 100 parts by mass of cerium oxide.

(CL-2): A composition including 90 mass % of “polyallylamine (manufactured by Nitto Boseki Co., Ltd)” and 10 mass % of “polyglycerol polyglycidyl ether (manufactured by Nagase Chemtex Corp.)” was used that was adjusted to a solid content concentration of 5 mass % by using distilled water as a solvent medium.

<Second Adhesive Layer (Thickness of 3 μm)>

An adhesive was used that was obtained by formulating a main resin and a multifunctional isocyanate compound, and carbodiimide illustrated in Table 1 at a ratio illustrated in Table 1. Toluene was formulated as appropriate in the adhesive to offer a non-volatile content of 15 mass %. Details of a main resin and a multifunctional isocyanate compound, and carbodiimide described in Table 1 are as follows.

{Main Resins}—acid-modified polyolefin (ratio of non-volatile content: 30 mass %, hydroxyl value: 40 KOHmg/g, manufactured by Riken Vitamin Co., Ltd., grade name: “Rikeaid MG-400EM”)
polyacrylic polyol (ratio of non-volatile content: 50 mass %, hydroxyl value: 10 to 20 KOH mg/g, functional group equivalent: 5610 g/mol, manufactured by MITSUBISHI RAYON CO., LTD., grade name: “LR209”)

{Multifunctional Isocyanate Compounds}—HDI-based (hexamethylene diisocyanate—adduct, ratio of non-volatile content: 50 mass %, NCO content: 18.7 mass %, functional group equivalent: 225 g/mol, manufactured by Asahi Kasei Corp., grade name: “E402-80B”)
TDI-based (tolylene diisocyanate—adduct, ratio of non-volatile content: 50 mass %, NCO content: 17.7 mass %, functional group equivalent: 237 g/mol, manufactured by Nippon Polyurethane Industry Co., Ltd., grade name: “Coronate L”)
IPDI-based (isophorone diisocyanate—adduct, ratio of non-volatile content: 74.6 mass %, NCO content: 10.3 mass %, functional group equivalent: 408 g/mol, manufactured by Mitsui Chemicals, Inc., grade name: “D-140N”)

### {Carbodiimide}

“V-07” (grade name, and the ratio of the non-volatile content was 50 mass %) manufactured by Nisshinbo Chemical Inc. was used as the carbodiimide.

<Metal Foil Layer (Thickness of 35 μm)>

A soft aluminum foil (manufactured by Toyo Aluminum K.K. and “8079 material”) was prepared that was subjected to annealing and degreasing treatments.

<Sealant Layer (Thickness of 40 to 70 μm)>

A material illustrated in Table 1 was used. Details of a material illustrated in Table 1 are as follows.
acrylic resin film (manufactured by Okura Industrial Co., Ltd. and trade name “OXIS-PMMA”)
polyester film (manufactured by TOYOBO Co., Ltd. and trade name “Olyester DE046”)
PP film (polypropylene film, manufactured by Idemitsu Kosan Co., Ltd., and trade name “Unilax RT-680CA”)

### [Manufacturing of Packaging Material]

### Examples 1 to 5 and Comparative Examples 1 to 3

A metal foil layer was bonded to a substrate layer by a dry lamination technique with an adhesive (first adhesive layer) and subjected to aging at 80° C. for 120 hours. Subsequently, a sealant layer was bonded to the surface of the metal foil layer opposite to the surface to which the first adhesive layer was bonded, by a dry lamination technique with an adhesive (second adhesive layer) and subjected to aging at 60° C. for 120 hours.

The laminate obtained in this way was subjected to heating treatment to manufacture a packaging material (substrate layer/first adhesive layer/metal foil layer/second adhesive layer/sealant layer).

### Examples 6 to 9

First, first and second anticorrosion treatment layers were provided on a metal foil layer in the following procedure. That is, both surfaces of the metal foil layer were coated with (CL-1) by micro-gravure coating at a dry coating weight of 70 mg/m² and subjected to baking treatment at 200° C. in a drying unit. Subsequently, the obtained layer was coated with (CL-2) by micro-gravure coating at a dry coating weight of 20 mg/m², thereby forming composite layers including (CL-1) and (CL-2) as the first and second anticorrosion treatment layers. These composite layers developed anticorrosion performance by compounding the two materials (CL-1) and (CL-2).

Except that the metal foil layer provided with these first and second anticorrosion treatment layers was used, a packaging material (substrate layer/first adhesive layer/first anticorrosion treatment layer/metal foil layer/second anticorrosion treatment layer/second adhesive layer/sealant layer) was manufactured as in Example 1.

### [Evaluation of Packaging Material]

### Examples 1 to 9 and Comparative Examples 1 and 2

### {Measurement of Infrared Absorption Spectrum Peak}

A packaging material was cut to peel a sealant layer and a metal foil layer apart or peel a sealant layer and an anticorrosion treatment layer apart. An infrared absorption spectrum peak was measured for the outermost surface of the second adhesive layer exposed by peeling by attenuated total reflection (ATR: Attenuated Total Reflection) Fourier transform infrared (FT-IR) spectroscopy. X defined by the following Formula (2) was calculated from the intensities in the infrared absorption spectra. The results are illustrated in Table 2.

$$X = \{ ( C + D ) - B \} / A \qquad ( 2 )$$

[where A to D represent intensities in infrared absorption spectra of the second adhesive layer measured by infrared spectroscopy, A represents a maximum intensity between wavenumbers of 3040 and 2760 cm-¹, B represents a maximum intensity between wavenumbers 1850 and 1780 cm-¹, C represents a maximum intensity between wavenumbers 1760 and 1600 cm-¹, and D represents a maximum intensity between wavenumbers of 2150 and 2090 cm-¹.]

Details of a measurement device and conditions are as follows.

### (Measurement Device and Conditions)

Measurement device: Spectrum Spotlight 400 (trade name and manufactured by PerkinElmer, Inc.)
Prism: germanium
Wavenumber resolution: 4 cm-¹
Integration count: 4 times
Baseline: straight line section between wavenumbers 2400 and 2600 cm-¹

### [Evaluation of Lamination Strength]

### (Lamination Strength in Environment of 80° C.)

A packaging material cut to have a width of 15 mm was left in a high-temperature environment of 80° C. for five minutes. After that, the lamination strength between a metal foil layer and a sealant layer of the packaging material in an environment of 80° C. was measured by a 90-degree peel test using a tensile testing machine (manufactured by Shimadzu Corporation) under a condition of a tensile rate of 50 mm/minute. In addition, an evaluation was made in accordance with the following criteria on the basis of the obtained lamination strength. The results are illustrated in Table 2.
A: The lamination strength was 2.5 N/15 mm or more
B: The lamination strength was 2.0 N/15 mm or more and less than 2.5 mm
C: The lamination strength was 1.5 N/15 mm or more and less than 2.0 mm
D: The lamination strength was less than 1.5 N/15 mm

### (Lamination Strength in Environment of 150° C.)

Except that the packaging material was left at a temperature of 150° C. and a 90-degree peel test was carried out at a temperature of 150° C., the lamination strength was measured in an environment at 150° C. as with the measurement of lamination strength in an environment of 80° C. and the obtained lamination strength was evaluated. The results are illustrated in Table 2.

(Lamination Strength after Hydrogen Sulfide Exposure)

A packaging material cut to have a width of 15 mm was left in an environment having a hydrogen sulfide concentration of 20 ppm at 100° C. for one week. After that, the lamination strength between a metal foil layer and a sealant layer of the packaging material in an environment at 150° C. was measured in a 90-degree peel test using a tensile testing machine (manufactured by Shimadzu Corporation) under a condition of a tensile rate of 50 mm/minute. The obtained lamination strength was evaluated in accordance with the criteria similar to those of the lamination strength in an environment of 80° C. The results are illustrated in Table 2.

### [Evaluation of Heat-Resistant Sealing Strength]

A packaging material was cut to have a size of 120 mm×60 mm and folded in half with a sealant layer located on the inside. Subsequently, the edges opposite to the folded portion were subjected to heat sealing at 220° C./at 0.5 MPa/for three seconds at a width of 10 mm and stored at room temperature for six hours. After that, the middle portion of the heat sealing portion in the longitudinal direction was cut out at a width of 15 mm×a length of 300 mm to fabricate a sample for measuring heat seal strength. After this sample was left in a test environment of 150° C. for five minutes, the heat-sealed portion of the sample was subjected to a T-peel test by using a tensile testing machine (manufactured by Shimadzu Corporation) under a condition of a tensile rate of 50 mm/minute. An evaluation was then made in accordance with the following criteria on the basis of the obtained heat sealing strength. The results are illustrated in Table 2.
A: The heat sealing strength was 15 N/15 mm or more
B: The heat sealing strength was 10 N/15 mm or more and less than 15 N/15 mm
C: The heat sealing strength was 5 N/15 mm or more and less than 10 N/15 mm
D: The heat sealing strength was less than 5 N/15 mm

### [Evaluation of Moisture Barrier Properties]

Packaging materials of 120 mm×110 mm were overlaid with sealant layers opposed to each other and folded to have an outer shape dimension of 120 mm×55 mm. Subsequently, the edges on both sides were subjected to heat sealing at 220° C./0.5 MPa/3 seconds at a width of 10 mm and a bag having one open side was fabricated. After that, 3 mL of dehydrated ethylene glycol was injected to the contents and the one remaining side was subjected to heat sealing with a width of 3 mm. It is to be noted that the sealing portion having a width of 10 mm was considered to allow substantially no moisture to permeate and the 3-mm sealing portion was to be measured. The fabricated battery container was stored in an environment at 120° C. and 90% RH for four weeks, the amount of moisture included in ethylene glycol after the battery container was stored was measured in the Karl Fischer method, and the moisture permeability was measured. An evaluation was made in accordance with the following criteria on the basis of the obtained moisture permeability. The results are illustrated in Table 2.
A: The moisture permeability was 250 ppm or less
B: The moisture permeability was greater than 250 ppm and less than or equal to 300 ppm
C: The moisture permeability was greater than 300 ppm and less than or equal to 350 ppm
D: The moisture permeability was greater than 350 ppm

### [Overall Evaluation]

An overall evaluation of a packaging material was made in accordance with the following criteria. The total value of the respective evaluations is the total value in which the evaluation criteria “A”, “B”, “C”, and “D” for evaluating the lamination strength, the heat-resistant sealing strength, and the moisture barrier properties respectively correspond to 3 points, 2 points, 1 point, and 0 points. The results are illustrated in Table 2.
A: The total value oft he respective evaluations is 13 points or more.
B: The total value of the respective evaluations is 9 points or more and 12 points or less. A case is, however, excluded where even one D rank is included
C: The total value of the respective evaluations is 5 points or more and 8 points or less. A case is, however, excluded where even one D rank is included
D: Each evaluation includes one or more D ranks

TABLE 1

| | Second adhesive layer | | | | | | Presence or | | |
|---|---|---|---|---|---|---|---|---|---|
| | Type of material | | Formulation ratio (parts by mass) | | | | absence of | Type of | |
| | | Multifunctional | | Multifunctional | | Hydrogen | anticorrosion | material | |
| | | isocyanate | Main | isocyanate | Carbodiimide | sulfide | treatment | of sealant | |
| | Main resin | compound | resin | compound | compound | adsorbent | layer | layer | X |
| Example 1 | Acid-modified | Ipdi-based | 100 | 1.0 | 0.5 | 0 | Absent | Acrylic | 0.01 |
| | polyolefin | | | | | | | resin film | |
| Example 2 | Acid-modified | Ipdi-based | 100 | 1.9 | 1.2 | 0 | Absent | Acrylic | 0.36 |
| | polyolefin | | | | | | | resin film | |
| Example 3 | Acid-modified | Ipdi-based | 100 | 1.9 | 1.8 | 0 | Absent | Acrylic | 0.57 |
| | polyolefin | | | | | | | resin film | |
| Comparative | Acid-modified | Ipdi-based | 100 | 0.6 | 0.3 | 0 | Absent | Acrylic | 0.005 |
| example 1 | polyolefin | | | | | | | resin film | |
| Comparative | Acid-modified | Ipdi-based | 100 | 1.9 | 2.1 | 0 | Absent | Acrylic | 0.64 |
| example 2 | polyolefin | | | | | | | resin film | |
| Comparative | Polyacrylic | Ipdi-based | 100 | 1.9 | 1.2 | 0 | Absent | Acrylic | — |
| example 3 | polyol | | | | | | | resin film | |
| Example 4 | Acid-modified | Hdi-based | 100 | 1.8 | 1.4 | 0 | Absent | Acrylic | 0.38 |
| | polyolefin | | | | | | | resin film | |
| Example 5 | Acid-modified | Tdi-based | 100 | 1.8 | 1.4 | 0 | Absent | Acrylic | 0.35 |
| | polyolefin | | | | | | | resin film | |
| Example 6 | Acid-modified | Hdi-based | 100 | 1.8 | 1.4 | 0 | Present | Acrylic | 0.38 |
| | polyolefin | | | | | | | resin film | |
| Example 7 | Acid-modified | Hdi-based | 100 | 1.8 | 1.4 | 0 | Present | Polyester | 0.38 |
| | polyolefin | | | | | | | film | |
| Example 8 | Acid-modified | Hdi-based | 100 | 1.8 | 1.4 | 0 | Present | Pp film | 0.38 |
| | polyolefin | | | | | | | | |
| Example 9 | Acid-modified | Hdi-based | 100 | 1.8 | 1.4 | 1.0 | Present | Pp film | 0.38 |
| | polyolefin | | | | | | | | |

TABLE 2

| | | | | | | | Heat-resistant | | | | |
|---|---|---|---|---|---|---|---|---|---|---|---|
| | Heat-resistant lamination strength | | | | | | sealing strength | | | | |
| | Environment | | Environment | | Hydrogen sulfide | | Environment | | | | |
| | of 80° C. | | of 150° C. | | exposure environment | | of 150° C. | | Moisture barrier | | |
| | Measure- | | Measure- | | Measure- | | Measure- | | properties | | Overall |
| | ment value | Eval- | ment value | Eval- | ment value | Eval- | ment value | Eval- | Measurement | Eval- | eval- |
| | (N/15 mm) | uation | (N/15 mm) | uation | (N/15 mm) | uation | (N/15 mm) | uation | value (ppm) | uation | uation |
| Example 1 | 2.40 | B | 1.60 | C | 1.50 | C | 6.00 | C | 310 | C | C |
| Example 2 | 2.70 | A | 2.10 | B | 1.60 | C | 8.00 | C | 310 | C | C |
| Example 3 | 3.00 | A | 2.20 | B | 1.80 | C | 8.00 | C | 340 | C | C |
| Comparative | 1.30 | D | 0.80 | D | 0.40 | D | 3.00 | D | 320 | C | D |
| example 1 | | | | | | | | | | | |
| Comparative | 3.00 | A | 2.20 | B | 1.80 | C | 8.00 | C | 400 | D | D |
| example 2 | | | | | | | | | | | |
| Comparative | 3.10 | A | 2.40 | B | 2.20 | B | 11.00 | B | 550 | D | D |
| example 3 | | | | | | | | | | | |
| Example 4 | 2.80 | A | 2.10 | B | 1.60 | C | 8.00 | C | 260 | B | B |
| Example 5 | 2.90 | A | 2.20 | B | 1.60 | C | 8.30 | C | 280 | B | B |
| Example 6 | 3.10 | A | 2.40 | B | 2.30 | B | 8.60 | C | 260 | B | B |
| Example 7 | 3.10 | A | 2.60 | A | 2.40 | B | 14.00 | B | 260 | B | B |
| Example 8 | 3.60 | A | 2.70 | A | 2.40 | B | 16.00 | A | 230 | A | A |
| Example 9 | 3.60 | A | 2.70 | A | 2.60 | A | 16.00 | A | 220 | A | A |

The gist of the present disclosure resides in [1] to [9] below.

[1] A packaging material for a power storage device, the packaging material including
a laminated structure including a substrate layer, a first adhesive layer, a metal foil layer, a second adhesive layer, and a sealant layer in this order, in which
the second adhesive layer includes a reaction product of at least an acid-modified polyolefin and a multifunctional isocyanate compound, and
the second adhesive layer satisfies a condition expressed by an inequality of the following Formula (1):

$$0.01 \leq \{ ( C + D ) - B \} / A \leq 0 \text{.60} \qquad ( 1 )$$

[where A to D represent intensities in infrared absorption spectra of the second adhesive layer measured by infrared spectroscopy, A represents a maximum intensity between wavenumbers 3040 and 2760 cm-¹, B represents a maximum intensity between wavenumbers 1850 and 1780 cm-¹, C represents a maximum intensity between wavenumbers 1760 and 1600 cm-¹, and D represents a maximum intensity between wavenumbers 2150 and 2090 cm-¹.]

[2] The packaging material according to [1], in which the multifunctional isocyanate compound includes at least one selected from the group of multimers of aliphatic multifunctional isocyanate compounds and multimers of multifunctional isocyanate compounds including an aromatic ring.

[3] The packaging material according to [1] or [2], including an anticorrosion treatment layer between the first adhesive layer and the metal foil layer or between the second adhesive layer and the metal foil layer, or anticorrosion treatment layers between the first adhesive layer and the metal foil layer and between the second adhesive layer and the metal foil layer.

[4] The packaging material according to any of [1] to [3], in which the sealant layer includes at least one of a polyolefin-based resin and a polyester-based resin.

[5] The packaging material according to any of [1] to [4], in which at least one of the first adhesive layer and the second adhesive layer includes a hydrogen sulfide adsorbent.

[6] The packaging material according to any of [1] to [5], in which the second adhesive layer further includes a carbodiimide compound.

[7] The packaging material according to any of [1] to [6], in which the packaging material is for a solid-state battery.

[8] A power storage device including:
a power storage device body;
a current output terminal that extends from the power storage device body; and
the packaging material according to any of [1] to [7], the packaging material pinching the current output terminal and accommodating the power storage device body.

[9] The power storage device according to [8], in which the power storage device is a solid-state battery.

### REFERENCE SIGNS LIST

10 . . . Packaging material (packaging material for power storage device); 11 . . . Substrate layer (outer layer); 12 . . . First adhesive layer; 13 . . . Metal foil layer; 14a, 14b . . . Anticorrosion treatment layer; 15 . . . Second adhesive layer; 16 . . . Sealant layer; 50 . . . Power storage device.

What is claimed is:

1. A packaging material for a power storage device, comprising
a laminated structure including a substrate layer, a first adhesive layer, a metal foil layer, a second adhesive layer, and a sealant layer in this order, wherein
the second adhesive layer includes a reaction product of at least an acid-modified polyolefin and a multifunctional isocyanate compound, and
the second adhesive layer satisfies a condition expressed by an inequality of the following Formula (1):
$$0.01 \leq \{ ( C + D ) - B \} / A \leq 0 \text{.60} \qquad ( 1 )$$
[where A to D represent intensities in infrared absorption spectra of the second adhesive layer measured by infrared spectroscopy, A represents a maximum intensity between wavenumbers 3040 and 2760 cm-¹, B represents a maximum intensity between wavenumbers 1850 and 1780 cm-¹, C represents a maximum intensity between wavenumbers 1760 and 1600 cm-¹, and D represents a maximum intensity between wavenumbers 2150 and 2090 cm-¹.]

2. The packaging material of claim 1, wherein the multifunctional isocyanate compound includes at least one selected from a group of a multimer of an aliphatic multifunctional isocyanate compound and a multimer of a multifunctional isocyanate compound including an aromatic ring.

3. The packaging material of claim 1, comprising an anticorrosion treatment layer between the first adhesive layer and the metal foil layer or between the second adhesive layer and the metal foil layer, or anticorrosion treatment layers between the first adhesive layer and the metal foil layer and between the second adhesive layer and the metal foil layer.

4. The packaging material of claim 1, wherein the sealant layer includes at least one of a polyolefin-based resin and a polyester-based resin.

5. The packaging material of claim 1, wherein at least one of the first adhesive layer and the second adhesive layer includes a hydrogen sulfide adsorbent.

6. The packaging material of claim 1, wherein the second adhesive layer further includes a carbodiimide compound.

7. The packaging material of claim 1, wherein the packaging material is for a solid-state battery.

8. A power storage device, comprising:
a power storage device body;
a current output terminal that extends from the power storage device body; and
the packaging material of claim 1, the packaging material pinching the current output terminal and accommodating the power storage device body.

9. The power storage device of claim 8, wherein the power storage device is a solid-state battery.
